(19) United States
(12) Patent Application Publication
(10) Pub. No.: US 2026/0129096 A1
(43) Pub. Date: May 7, 2026

(54) METHOD FOR MANAGING SMART INTERNET OF THINGS HUB AND NODE INTERACTIONS

(71) Applicant: GM GLOBAL TECHNOLOGY OPERATIONS LLC, Detroit, MI (US)

(72) Inventors: Venkata Naga Siva Vikas Vemuri, Farmington Hills, MI (US); Azin Neishaboori, Plymouth, MI (US); Lakshmi V. Thanayankizil, Rochester Hills, MI (US); John Sergakis, Bloomfield Hills, MI (US); Scott T. Droste, West Bloomfield, MI (US); Ahmed F Al Alawy, Canton, MI (US)

(73) Assignee: GM GLOBAL TECHNOLOGY OPERATIONS LLC, Detroit, MI (US)

(21) Appl. No.: 18/938,768

(22) Filed: Nov. 6, 2024

(51) Int. Cl. H04L 67/12; B60L 58/12; G16Y 20/20; G16Y 40/35; H04W 84/18

(52) U.S. Cl. CPC H04L 67/12; B60L 58/12; G16Y 20/20; G16Y 40/35; H04W 84/18

(57) ABSTRACT

A method for managing communication between Internet-of-Things (IoT) nodes in an IoT environment having an IoT hub includes using a service-requesting, high power initiator node to identify a candidate smart device among the nodes. The smart device is flexibly operable as a low power or high power device, as a hybrid device, based on a parameter of the initiator node. The method may include selectively assigning the smart device as a trusted designated node within the IoT environment. The method also includes determining, based on the parameter, an optimal periodicity of communication of status messages from the trusted designated node to an IoT hub. Thereafter, the method includes transmitting the status messages to the hub with the optimal periodicity, via the trusted designated node, such that the trusted designated node acts as a proxy for the initiator node when reporting the status messages to the hub.

### INTRODUCTION

Advancements in global automation technology have led to the adoption of Internet of Things (IoT)-based solutions and associated management of the myriad of networked device types used to implement an IoT environment. Devices and communication nodes thereof in a networked IoT environment are used to collect and exchange messages, thereby enabling automation and optimizing device-performed processes. For example, home charging operations of a battery electric vehicle or a plug-in hybrid electric vehicle may be scheduled and managed using “smart garage” IoT network connectivity. Such a network may utilize smartphone-based monitoring and opening/closing operation of garage doors or other access points, control of climate settings such as temperature, humidity, and air quality, and monitoring/control of other networked systems. IoT networks may be used in other operating environments, including but not limited to a user's home or office. Modern industrial and manufacturing environments likewise may use a networked IoT ecosystem to facilitate placement of orders, track assembly progress, or otherwise communicate between different networked devices.

Communication between nodes of a networked IoT environment rely on proximity ranging and the reliable exchange of other information via a coordinated exchange of electronic signals or messages. The networked devices/nodes may rely on one or more connectivity technologies such as Wi-Fi, Bluetooth, Bluetooth Low Energy (BLE), cellular, Zigbee, or other technologies to transmit such ranging data and information. Coordinated operation of the potentially disparate technologies across a networked IoT environment are currently facilitated by the open-source Matter standard, and therefore networked IoT ecosystems are often referred to as Matter networks. Regardless of the construction or subnetworks used in a networked IoT ecosystem, constituent nodes of the ecosystem are required to periodically communicate with an IoT hub to maintain status within and control of the ecosystem.

### SUMMARY

The present disclosure pertains to methods and systems for managing and controlling a networked Internet-of-Things (IoT) ecosystem having one or more IoT hubs and a plurality of networked smart devices. Each smart device includes/functions as one or more communication nodes within the IoT ecosystem. As used herein, the IoT hub is a centralized hardware and software device that connects and manages the ongoing exchange of data/messages between connected IoT devices. The IoT hub, which may be either local or global/cloud-based in different implementations, thus acts as a centralized communication node during the exchange of messages between the connected devices. Several examples of such messages include activation or deactivation commands, telemetry data, performance metrics, software/firmware updates, error conditions, status, security credentials, time stamps, state of health reports, and other relevant information or data.

In accordance with an aspect of the disclosure, a trusted designated node is dynamically or statically assigned by a service-requesting device (“initiator node”) or an IoT hub in different embodiments. Assignment occurs based on a parameter of the initiator node, for instance its current power level or state of charge. The designated node is thereafter used as a “trusted node” as part the IoT ecosystem, specifically for the purpose of providing status messages to the IoT hub on behalf of the initiator node. As disclosed herein, the term “hybrid device” refers to a high power smart device such as an electric vehicle (EV) or a controller having multiple processors/other computational nodes. At times, the high power device may experience a depleted battery or reduced energy budget, and thus begin to act more like a low power device. Thus, using a parameter in the form of, e.g., a reduced capacity level or state of charge of a propulsion battery of an electric vehicle (EV) when the initiator node/smart device is the EV, the designated node negotiates optimal engagement periodicity with the IoT hub.

In the non-limiting case of the example EV and its resident propulsion battery, periodic message transmission between the EV and the IoT hub during an ignition-off mode of the EV could rapidly discharge and further deplete the propulsion battery or another onboard energy storage system used for this purpose. To address this problem, the method set forth herein includes selectively introducing the trusted designated node into the IoT environment as a trusted node and messaging proxy. The task of selecting the trusted designated node is performed as needed by either the service-requesting initiator node/device or by the IoT hub in different embodiments. The introduced trusted designated node thereafter acts as a proxy for status reporting and other message exchanges with the IoT hub, and negotiates optimal periodicity of such reporting.

A method for managing communication between IoT nodes in a networked IoT environment having an IoT hub in accordance with an embodiment includes determining a parameter (e.g., the above-noted capacity level, state of charge, energy budget, etc.) of a service-requesting, high power initiator node of the IoT network, e.g., an EV. The method includes identifying, based on the parameter, whether the initiator node is operating in a hybrid power mode. When the initiator node is operating in the hybrid mode, which as used herein occupies a space between high power and low power modes, the method includes identifying a candidate smart device/node among a plurality of neighboring nodes of the IoT network. The method includes selectively assigning the candidate smart device as a trusted designated node within the IoT network. The method also includes determining, based on the parameter of the initiator node, an optimal periodicity of communication of status messages from the trusted designated node to the IoT hub. Thereafter, the method includes transmitting the status messages to the IoT hub with the optimal periodicity via the trusted designated node, such that the trusted designated node acts as a proxy for the initiator node when reporting the status messages to the IoT hub.

The initiator node may include a battery, in which case the parameter includes a capacity level or state of charge of the battery. The initiator node in one or more embodiments is part of a vehicle having the battery. Determining the optimal periodicity of communication of the status messages in such embodiments is based on the capacity level or state of charge of the battery.

Selectively introducing the candidate smart device into the IoT environment may include selectively introducing an electric vehicle charger into the IoT environment as the trusted designated node, with the electric vehicle charger including the candidate smart device.

Selectively introducing the candidate smart device into the IoT environment may occur during commissioning of the candidate smart device.

The optimal periodicity of communication of the status messages from the trusted designated node to the IoT hub may include accessing a lookup table that is indexed or referenced by the optimal periodicity and the parameter.

Selectively introducing the candidate smart device into the IoT environment may optionally include dynamically assigning the candidate smart device type as the trusted designated node during operation of the IoT environment. For instance, the IoT environment may be part of a manufacturing plant, such that dynamically assigning the candidate smart device as the trusted designated node includes dynamically assigning an automation robot or a controller of the manufacturing plant as the trusted designated node during operation of the manufacturing plant. Dynamically assigning the candidate smart device as the trusted designated node may also be performed by the initiator node in accordance with a device-acquired model, such as by selecting the trusted designated node via the initiator node from among neighboring/in-range nodes of the IoT nodes using the device-acquired model. Alternatively, dynamically assigning the candidate smart device as the trusted designated node may be performed by the IoT hub in accordance with a hub-assisted model.

Embodiments of the method may include consolidating a status message of the initiator node with a status message of the trusted designated node to form a consolidated report, and periodically sending the consolidated report to the IoT hub via the trusted designated node to thereby reduce power consumption of the IoT environment.

In accordance with an aspect of the disclosure, a networked IoT environment includes an IoT hub and a plurality of IoT devices. The devices include a service-requesting device (“initiator node”). The IoT hub and/or the initiator node is operable for identifying, in response to a parameter of the initiator node, a candidate smart device from among the plurality of IoT devices, and selectively introducing the candidate smart device into the IoT environment. This latter step may include assigning the candidate smart device as a trusted designated node within the IoT environment, via the initiator node and/or the IoT hub. The trusted designated node in this particular embodiment is operable for determining, based on the parameter of the initiator node, an optimal periodicity of communication of status messages from the trusted designated node to the IoT hub. The trusted designated node is also operable for transmitting the status messages to the IoT hub with the optimal periodicity such that the trusted designated node acts as a proxy for the initiator node when reporting the status messages to the IoT hub.

In another aspect of the disclosure, an IoT environment includes an IoT hub, a vehicle, and a vehicular infrastructure device. The vehicle includes a vehicle body, one or more road wheels connected to the vehicle body, and a battery connected to the vehicle body. The battery for its part includes a capacity level or state of charge. The vehicle in this embodiment acts as a service-requesting device (“initiator node”) within the IoT environment. The vehicle is operable for identifying, in response to the capacity level or state of charge, a candidate smart device from among a plurality of IoT devices of the IoT environment. The vehicle is also operable for selectively introducing the candidate smart device into the IoT environment by assigning the candidate smart device as a trusted designated node within the IoT environment. The vehicular infrastructure device in this implementation is operable for determining, based on the capacity level or state of charge, an optimal periodicity of communication of status messages from the vehicular infrastructure device to the IoT hub. The vehicular infrastructure device is also operable for transmitting the status messages to the IoT hub with the optimal periodicity such that the vehicular infrastructure device acts as a proxy for the vehicle when reporting the status messages to the IoT hub.

The above-summarized features and other features and advantages of this disclosure will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a representative networked Internet of Things (IoT) ecosystem in which a statically assigned designated node is used in accordance with an embodiment.

FIG. 2 is a power assessment plot usable in the management or control of the IoT ecosystem of FIG. 1, with response periodicity shown on the vertical axis and battery level of an initiator device or node shown on the horizontal axis.

FIG. 3 illustrates a representative manufacturing line depicting a dynamically assigned designated node in accordance with an aspect of the disclosure.

FIG. 4 is a top-level block diagram illustrating negotiation and management of a designated node in the networked IoT ecosystems of FIGS. 1 and 3.

FIG. 5 is a model for selecting a designated node via an initiator device or node in accordance with an aspect of the disclosure.

FIG. 6 is an alternative model for selecting the designated node with the assistance of an IoT hub.

FIG. 7 is a multi-ecosystem/fabric model for consolidating messages in scenarios in which an initiator node of an IoT network sends messages or reports via different IoT hubs.

FIG. 8 is a flow chart illustrating an implementation of the fabric model illustrated in FIG. 7.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

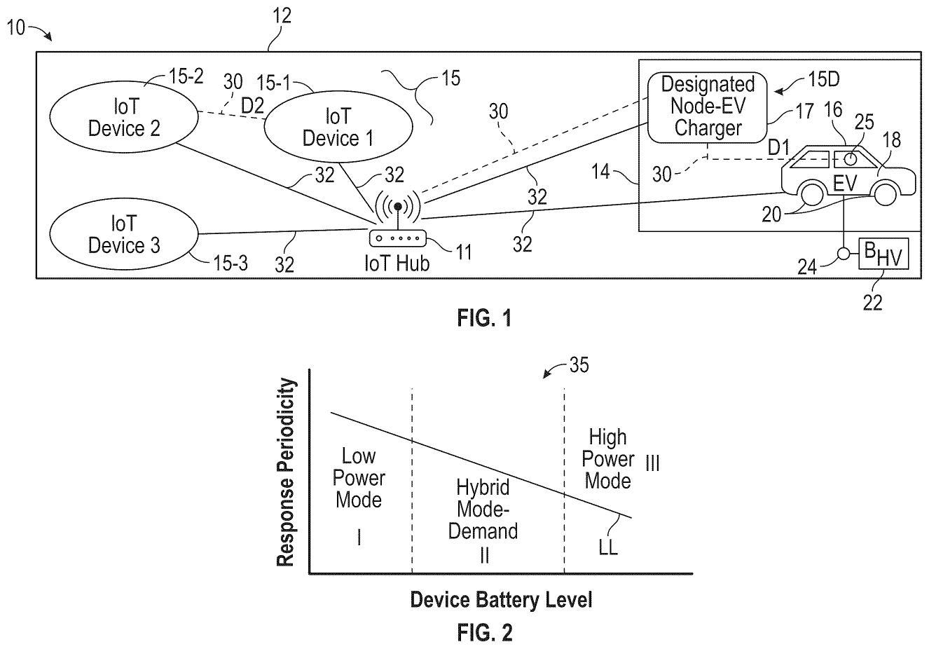

Referring now to the drawings, wherein like reference numbers refer to like features throughout the several views, a networked internet-of-things (IoT) ecosystem 10 having one or more IoT hubs 11 is illustrated in FIG. 1. The term “ecosystem” as used herein refers to a group of networked communication nodes having a common root certificate, i.e., a trusted digital certificate that establishes a chain of trust for device authentication, as appreciated in the art.

The IoT ecosystem 10 is shown in FIG. 1 as a non-limiting statically-assigned designated node implementation for a smart location 12, e.g., a smart home or building equipped with a smart garage 14. The smart location 12 may include a plurality of IoT devices 15-1, 15-2, and 15-3. The IoT devices 15-1, 15-2, and 15-3 in turn are collectively referred to herein for simplicity as nodes 15 of the IoT ecosystem 10. However, the terms “device” and “node” are different, and thus used in different contexts below.

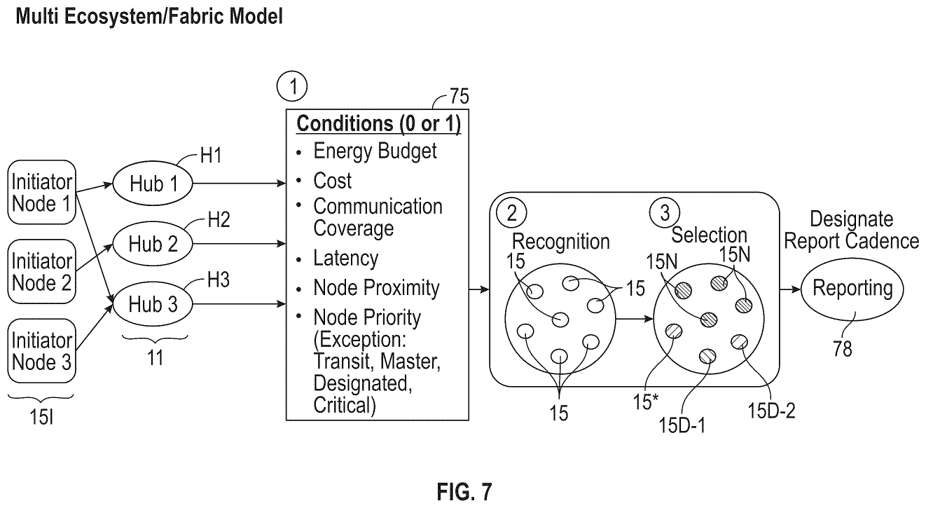

As used herein, devices such as the IoT devices 15-1, 15-2, and 15-3 are pieces of equipment containing or acting as one or more communication node. Nodes in turn are individually addressable, unique resources or logical entities within the IoT ecosystem 10 having functions and capabilities that a user of the IoT ecosystem 10 would recognize distinctly as a functional whole. A fabric as described below with reference to FIG. 7 is a set of nodes 15 that interact with each other by accessing data model elements in a given domain. The IoT ecosystem 10 within the scope of the disclosure may include more or fewer devices or nodes in other implementations, with the example static designated approach of FIG. 1 used hereinafter for illustrative simplicity and clarity. The IoT devices 15-1, 15-2, and 15-3 of FIG. 1 may include, e.g., a smartphone, a wireless/Wi-Fi-enabled thermostat, a garage door or other doors/access points, a security camera, an appliance, or one or more other smart devices.

As part of the overall management of the IoT ecosystem 10, periodic communication of status messages occurs between the nodes 15. This may occur via a low power mesh network protocol referred to as Thread, and/or the open-source Matter application layer protocol. In a common implementation, for instance, Thread may be used as a wireless communication method for controlling various Matter devices. The IoT ecosystem 10 of FIG. 1 may therefore be considered a Matter network, as will be appreciated by those of ordinary skill in the art.

In the representative embodiment of FIG. 1, the IoT ecosystem 10 includes additional nodes 15 in the form of an electric vehicle (EV) 16 and an EV charger 17, e.g., an electric vehicle supply equipment (EVSE) home charging station. Other vehicular embodiments may be used herein, including those having an internal combustion engine (ICE) or hybrid electric vehicles. In these or other implementations, the vehicle could be in communication with a vehicular ecosystem device that is also a Matter device. The trusted designated node 15D is thus a device that may function as a “trusted node” from the security standpoint of the initiator node 15I.

The EV charger 17 in embodiments in which the initiator node 15I is the EV 16 may therefore act as a trusted designated node 15D. In communication with the EV charger 17, the hybrid device-type of the exemplary EV 16 flexibility occupies an energy budget zone somewhere between and inclusive of a true high power device-type during its normal operation and a true low power device type when a battery level of the EV 16 becomes depleted. As such, the EV charger 17 (or another designated device in different embodiments) is statically or dynamically assignable to operate as a trusted designated node 15D within the networked IoT ecosystem 10 as an aspect of the solutions set forth herein.

Once assigned to act as a trusted designated node 15D, for instance by the EV 16 itself or by the IoT hub 11, or by another smart device in the IoT ecosystem 10, the EV charger 17 thereafter acts as a messaging service proxy for performing device status reporting operations, as well as for negotiating an optimal engagement periodicity with the IoT hub 11 for transmitting status messages within the IoT ecosystem 10. The EV 16 in this embodiment would retain the capability of sending pre-authorized high-priority or urgent messages directly to the IoT hub 11, with the described proxy function of the trusted designated node 15D otherwise handling the more routine message communication to the IoT hub 11. The EV 16 would also be able to send messages less frequently as needed based on its power levels, for situations in which the EV 16 does not assign the trusted designated node 15D.

The EV 16 of FIG. 1 in a representative electrified motor vehicle embodiment in which the IoT environment 10 is a vehicular IoT environment includes a vehicle body 18 and one or more road wheels 20. The EV 16 is also equipped with a high-voltage propulsion battery (B_{HV}) 22 and one or more electric traction motors 24. ICE-based or hybrid electric vehicle alternative embodiments may use other types of batteries 22 for other purpose, such as standby for engine start/stop events, lead acid or lithium starting batteries, smaller/limited distance propulsion batteries, etc. While other components are omitted from FIG. 1 for illustrative simplicity, the EV 16 may also include power electronic equipment such as a power inverter module operable for inverting a direct current (DC) voltage waveform from the propulsion battery 22 when energizing phase windings of alternating current (AC) embodiments of the electric traction motor(s) 24, a DC-to-DC converter for regulating the DC voltage waveform to or from the propulsion battery 22, thermal management systems for maintaining a temperature of the propulsion battery 22 and electric traction motor(s) 24, etc.

When an operator of the EV 16 returns to the smart garage 14 in a representative use scenario, an onboard charging controller or other smart device 25 of the EV 16 may communicate with the EV charger 17 via transmission of message data 30 (dotted line) over a first link (D1). Similar message data 30 may be exchanged between the EV charger 17 and the IoT hub 11. In the example implementation of FIG. 1, therefore, the dotted line depiction of the message data 30 represents periodic communication of lower priority/default information/messages to the IoT hub 11 on behalf of the EV 16.

Also illustrated in FIG. 1 are internal data 32 (solid line) representing communication of internal data from the trusted designated node 15D, with the statically (unchanging) trusted designated node 15D in this exemplary use case being the EV charger 17 and its associated processor/control circuitry (not shown but appreciated in the art). The EV charger 17 thereafter communicates as needed with one or more of the IoT devices 15-1, 15-2, and/or 15-3 within the smart home 12, with a representative link (D2) also shown in FIG. 1 between IoT devices 15-1 and 15-2. Similar to the described EV 16-to-EV charger 17 link (D1), that is, link D2 indicates that one of the IoT devices 15-1 or 15-2 may function as a hybrid device type of initiator node, similar to the EV 16, in which case the other device 15-1 may be used as the designated node (or vice versa). The EV 16 in this embodiment retains the capability of communicating directly with the IoT hub via internal data 32, e.g., when the information is a fault or other high-priority or urgent messenger. As noted above, the device types and the use/configuration of the IoT ecosystem 10 may vary with the intended application, and therefore the example shown in FIG. 1 is illustrative of the present teachings and nonlimiting thereof.

Other (drawings-omitted) hardware associated with the various nodes 15 may be in the form of one or more Application Specific Integrated Circuit(s) (ASIC), Field-Programmable Gate Array (FPGA), electronic circuit(s), central processing unit(s), e.g., microprocessor(s) or processors, and associated computer readable storage medium/memory. Non-transitory components of such memory, including the computer storage medium, are capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Using such hardware and associated antenna, receivers, and transmitters residing at the various nodes, therefore, information may be exchanged wirelessly between nodes.

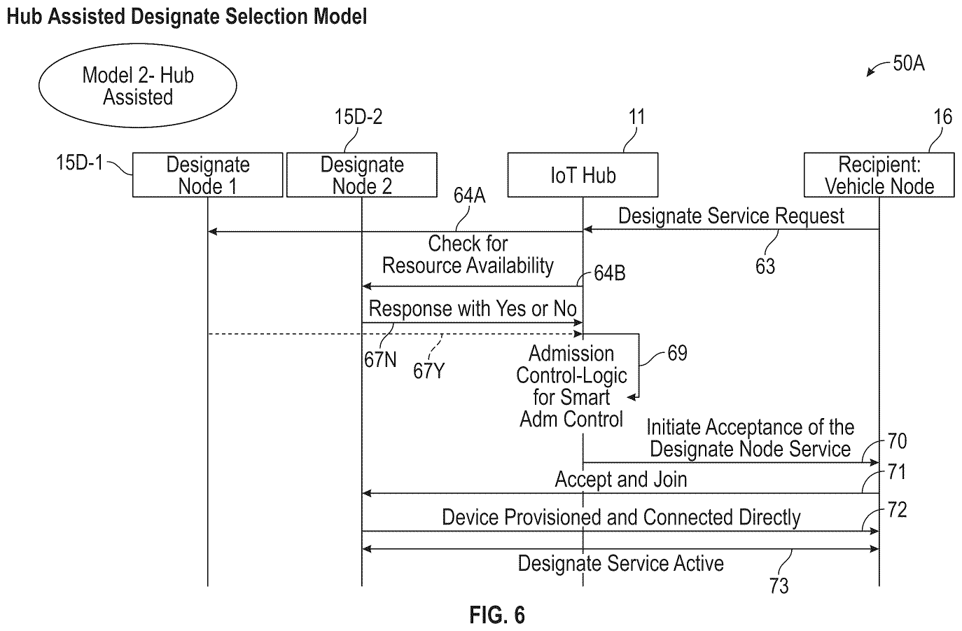

Hybrid Device-Type Based Selection: Referring to plot 35 of FIG. 2 in conjunction with the networked IoT ecosystem 10 of FIG. 1, a hybrid device type such as the EV 16 selects a trusted designated node 15D as part of the present strategy. The power level or state of charge is assessed for an initiating or service requesting node (initiator node 15I of FIGS. 54 and 6) within the networked IoT ecosystem 10, for instance the EV 16. The initiator node is a hybrid device-type within the scope of the present disclosure, and may therefore act when needed as either a high power or a low power device type, with the actual mode being based on one or more parameters of the initiator node 15I, and thus current conditions or situations. In the present IoT context, the relative terms “high power” and “low power” are distinguishable from each other by their relative level of energy consumption, as well as by their computational capabilities and communication characteristics. The construction of the devices constituting the nodes 15 of FIG. 1 may vary with the application.

Exemplary low power device types include small battery-powered actuators or sensors, radio frequency identification (RFID) tracking devices, wearable monitors or other smart devices, etc. Such devices tend to have relatively low data transmission rates, and may also follow appropriate communication protocols such as Bluetooth Low-Energy (BLE) or Zigbee. In contrast, high power device types in the IoT context considered herein may consume significantly more energy, and may involve complex data processing/transmission. The IoT hub 11 of FIG. 1, for example, may operate as a high power device type, as may the EV charger 17, an onboard controller of the EV 16, etc. High power IoT devices may also follow different communication protocols, typically but not limited to Wi-Fi or Ethernet. The term “hybrid” as used herein therefore refers to the capability of the trusted designated node 15D of FIG. 1 to occupy an energy budget zone anywhere between the characteristics of high power and low power device types. The hybrid device type is therefore capable of operating as a high power or low power device as the situation warrants.

In the representative usage scenario of FIG. 1, the EV 16 (a high power device) is parked in the smart garage 14 in close ranging proximity to the EV charger 17 while in an ignition-off mode. In this mode, the propulsion battery 22 or other connected batteries/energy storage systems may tend to drain power at a higher than acceptable rate as noted above. With this representative scenario in mind, the plot 35 of FIG. 2 illustrates message response periodicity on the vertical axis. Battery level, in this case a state of charge or remaining capacity of the propulsion battery 22, is shown on the horizontal axis.

In accordance with the disclosure, a smart device is selected and introduced into the IoT ecosystem 10 to thereafter act as the trusted designated node 15D, for example selected by the EV 16 or the IoT hub 11. The smart device may be a hybrid or low power device type, and may be or may include the EV charger 17. The smart device now acting as the trusted designated node 15D thereafter negotiates an optimal engagement periodicity with the IoT hub 11 when sending status messages 30 on behalf of the EV 16. The trusted designated node 15D thus acts as a proxy for reporting device status from the EV 16, as well as performing other interactions with the various nodes 15 of the IoT hub 11.

In FIG. 2, plot 35 depicts three different energy budget zones or power modes. The three example modes include low power (mode I), hybrid power (mode II), and high power (mode III). A line LL represents the inverse relationship that exists between response periodicity on one hand and battery level/state of charge on the other. Battery level, acting as a reference parameter in this example, may represent the remaining capacity of a battery, e.g., the propulsion battery 22 of FIG. 1, powering the initiator node/device, e.g., the EV 16.

When the EV 16 has a high battery level, the EV 16 may continue to report its own message traffic to the IoT hub 11 with a predetermined or self-negotiated frequency/periodicity. This is the default/normal operating mode of the EV 16, which would be the sole default without the benefit of the present solutions. Within the scope of the disclosure, as the battery level decreases the EV 16 moves from high power (mode III) toward low power (mode I) capability. As the EV 16 (or another initiator node) progresses toward mode I, the EV 16 will first pass into mode II, i.e., hybrid mode. Here, the EV 16 (or the IoT hub 11) selectively assigns a smart device/node to act as the trusted designated node 15D, thus offloading the reporting task from the initiator node to the trusted designated node 15D. Low power (mode I) may be used by the designated node 15D to communicate messages within the IoT network 10 when the battery level of the initiator node 15I is relatively low or nearly depleted. In one or more embodiments, therefore, the act of determining optimal periodicity of communication of status messages by the trusted designated node 15D on behalf of the EV 16 (or other initiator node 15I) to the IoT hub 11 may include accessing a lookup table that is indexed or reference by the optimal periodicity and a parameter of the initiator node 15I, which in this instance includes the battery level/state of charge of the propulsion battery 22.

Message Periodicity: In general, each node of a typical Matter ecosystem is required to periodically communicate with an IoT hub to maintain status in the Matter network. Messages transferred within the example networked IoT environment 10 of FIG. 1 may be of distinct types and convey particular information. For example, messages types may include Address Resolution Protocol (ARP), Neighbor Discovery Protocol (NDP), Dynamic Host Configuration Protocol (DHCP), Internet Control Message Protocol (ICMP), Message Queuing Telemetry Transport (MQTT), etc. Periodicity of message transmission depends on the device type, i.e., high power or low power.

Additionally, periodicity is typically fixed on a maximum time limit across the Layer 2, Layer 3, and Layer 4 IoT stack. As appreciated in the art, Layer 2 (i.e., the L2/Data Link Layer), is generally responsible for node-to-node data transfer within the network, which in a Matter network is typically IEEE 802.15.4 (Thread/ZigBee) or Wi-Fi. L2 messages may include error detection, physical addressing of the various devices, media access control (MAC) addressing, etc. Layer 3 (i.e., the L3/Network Layer), is responsible for routing and logical addressing across network segments, message packet forwarding, and implementing Thread, Wi-Fi, and other network connectivity protocols. Layer 4 (i.e., the L4/Transport Layer), is responsible for establishing connections and managing end-to-end communication between connected devices, among other tasks. Layers L2, L3, and L4 collectively enable a standardized IoT communication framework, facilitating the effective use of devices manufactured by the same or different manufacturers.

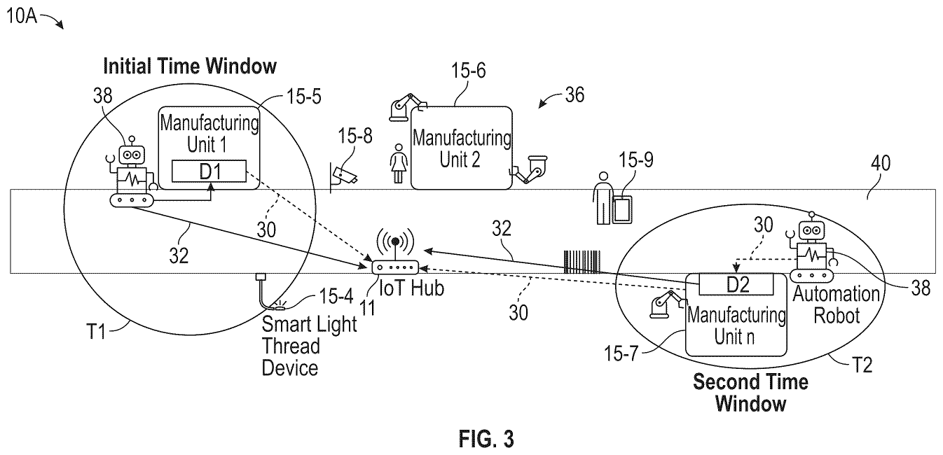

A potential problem with managing device type-dependent message periodicity using existing standards may be encountered when attempting to manage communication to/from high power device types such as the representative EV 16 of FIG. 1, or other devices/nodes having a depleted energy state. Existing Matter-based and other approaches for managing node interaction between the nodes 15 and the IoT hub 11 of FIG. 1 cannot efficiently handle increasing the rate of reporting for such devices. The present solutions therefore selectively reengage with the IoT hub 11 using a trusted designated node 15D, doing so based on energy constraints or other parameters of the service-requesting node/device as exemplified in FIG. 2, possibly using dynamic selection of the trusted designated node 15D (FIG. 3) when acting as a proxy for message communication.

Dynamic Assignment: Referring briefly to the networked IoT infrastructure 10A of FIG. 3, a device/node may be dynamically assigned rather than being statically assigned as in the FIG. 1 example. Dynamic assignment may be used in an exemplary manufacturing plant in which automation robots 38 are arranged relative to a manufacturing line 40. Various IoT devices 15-4, 15-5, 15-6, 15-7, 15-8, and 15-9 are illustrated in FIG. 3. Production or manufacturing is sequential in this example, such that one of the robots 38 is located in an initial time window T1 upstream or downstream of another robot 38 in a second/later time window T2.

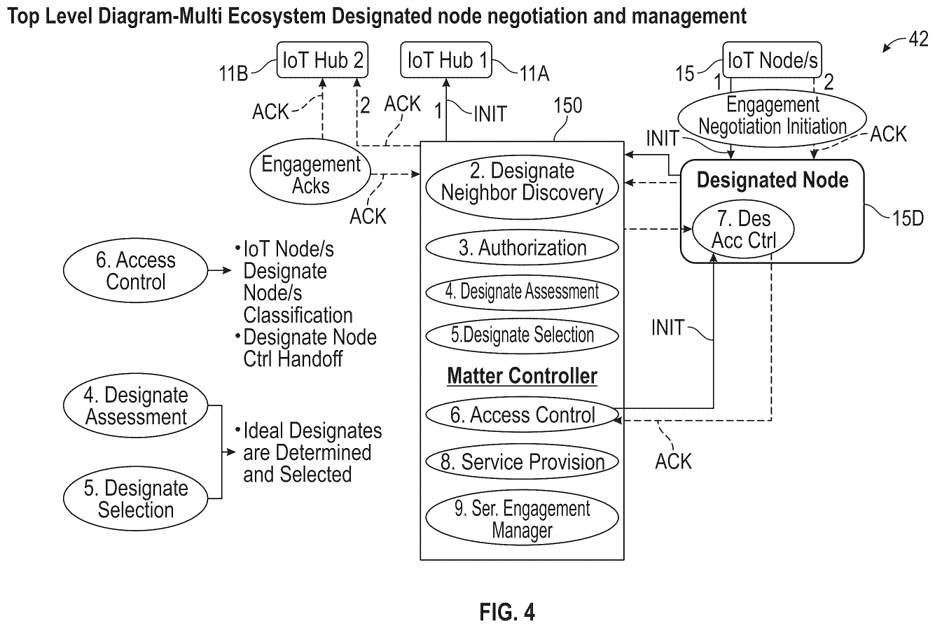

The IoT device 15-4 in the non-limiting example implementation of FIG. 4 may be constructed as a smart light Thread device, while the IoT devices 15-5, 15-6, and 15-7 may be manufacturing control units/controllers. While one device 15-7 is shown, the networked IoT infrastructure 10A may include a plurality of additional such devices 15-7, i.e., an integer n.

Thus, “manufacturing unit n” represents one or more additional controllers along the manufacturing line 40. Device 15-8 may include an RFID tag reader for asset tracking. Device 15-9 is illustrated as a smart phone. Various other devices may be used in a manufacturing plant, and therefore the examples of FIG. 3 are illustrative of the present teaching and non-limiting thereof. Being dynamically assigned, the identity of the trusted designated node 15D may change during the operation.

As with the static example of FIG. 1 in which the identity of the trusted designated node 15D is fixed, the various devices/nodes may exchange message data 30 (dotted line). For instance, an automation robot 38 may communicate with the manufacturing controller (first device type D1) in the initial time window T1 while a downstream automation robot 38 communicates with the manufacturing controller (device type D2) in the second time window T2. The dotted line of the message data 30 represent periodic communication of information/messages to the IoT hub 11 on behalf of, e.g., the automation robots 38. Internal data 32 (solid line) as noted above represents communication of internal data from a designated node, e.g., one of the automation robots 38, which in this case changes dynamically as set forth below.

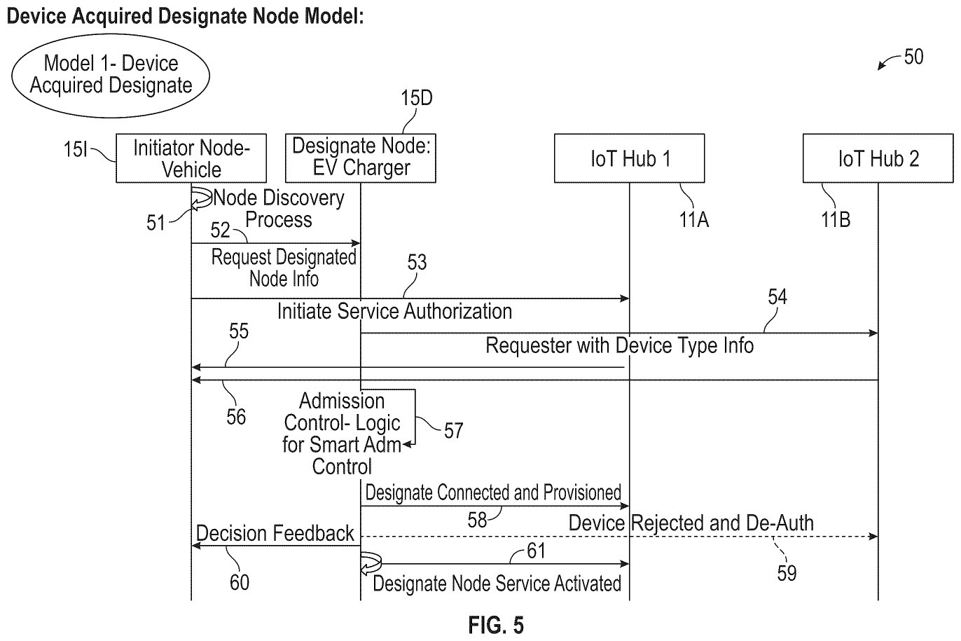

Referring to flow diagram 42 of FIG. 4 and continuing with the discussion of dynamic designation of a hybrid device type, designated nodes may be dynamically assigned in accordance with one of two different models: (i) a device-acquired model 50 as illustrated in FIG. 5, or (ii) a hub-assisted model 50A as illustrated in FIG. 6. In FIG. 4, two distinct types of IoT hubs 11 are shown as IoT hub 11A and IoT hub 11B. For example, the IoT hubs 11A and 11B may be respectively embodied as a smart switch and a voice assistant platform, e.g., Amazon Alexa, Siri, or Google Assistant. The IoT hub 11B may also be the EV 16 of FIG. 1 in another embodiment. A Matter controller 150 of one the IoT nodes 15 is also illustrated schematically in FIG. 4, e.g., a smartphone, infotainment system, etc. When the IoT environment 10A is part of a manufacturing plant as shown in FIG. 3, dynamically assigning the candidate hybrid device type as the trusted designated node 15D may include dynamically assigning an automation robot 38 or a manufacturing controller, e.g., 15-5, 15-6, or 15-7, as the trusted designated node 15D. This may occur during ongoing operation of a manufacturing line of the manufacturing plant, with the identity of the trusted designated node 15D possibly changing during the operation.

FIG. 4 generally illustrates a sequence of events that may be performed in accordance with the disclosure. The sequence commences with selection of a trusted designated node 15D within the networked IoT infrastructure 10 or 10A described above, or variations thereof. Arrows INIT indicate initiation signals. Arrows ACK indicate acknowledgement signals from the IoT hub 11A and trusted designated node 15D. The trusted designated node 15D is dynamically located and initially selected from among the nodes 15 using the exchange of signals INIT and ACK.

As part of this process, the Matter controller 150 performs a series of functions F1-F6. These include discovering candidate designated nodes from among discovered neighbor nodes (F2), authorizing use of the designated nodes (F3), assessing the communication and power capabilities of the designated nodes (F4) for ideal capabilities for the given situation, e.g., in terms of energy requirements, and selecting a designated node (F5) for use as a proxy. Access control functions (F6) may be performed with the trusted designated node 15D via corresponding functions (F6A) of the trusted designated node 15D. Such functions F6 may include handing off control to the trusted designated node 15D. Additional functions are performed by the designated node 15D, including service provision (F7) and management of the ongoing service (F8).

Referring to the device-acquired designated node model 50 of FIG. 5, in the representative case of FIG. 1 in which the EV 16 is used with the EV charger 17 and two IoT hubs, e.g., 11A and 11B of FIG. 5, permissions may be dynamically reclassified by one of the IoT hubs 11 as they dynamically monitor the nodes for compliance and other configuration information. Permissions, once active, may be managed by the nodes 15 upon receipt of new requests. Unless reclassified by the Matter controller 150 of FIG. 4, a trusted designated node 15D cannot nominate other nodes 15 to function as another trusted designated node 15D. Therefore, aspects of the disclosure may entail selectively reclassifying the trusted designated node 15D to enable it to do so.

Statically-designated Node: In an exemplary smart home implementation such as the use case of FIG. 1 when a given IoT device's location is readily available, for instance the EV charger 17 of FIG. 1 located in a fixed position within the smart garage 14, this device may be thereafter used as the trusted designated node 15D. The EV charger 17/other trusted designated node 15D, once assigned by the EV 16 or IoT hub 11 in this implementation, thereafter acts as a messaging proxy for the EV 16 for direct messaging engagements with the IoT hub 11. The status reporting may be consolidated with the status message of the trusted designated node 15D, i.e., its own status message to the IoT hub 11. In some cases as noted above, the EV 16 may also flag and transmit critical messages to the IoT hub 11 directly.

Designation of the trusted designated node 15D in the static designation case may occur during an IoT device commissioning process in one or more embodiments. As appreciated in the art, an IoT device commissioning process ensures network security by preventing spoofing, as well as preventing unauthorized or nefarious devices from joining the IoT network. During device commissioning, devices are configured for use in the IoT network, assigned operating parameters to ensure device/communications consistency, and manage network resources. Commissioning of a new device may include having the device broadcast its presence while scanning for available networks, e.g., using Bluetooth, BLE, Wi-Fi, Zigbee, or another suitable protocol. The device may then exchange security keys with other nodes of the network, receiving a unique device identifier, and verify its connectivity to the other nodes. Once commissioned, the new device is free to act within the IoT ecosystem 10, 10A as one of the various nodes 15.

Dynamically-designated Node: For the exemplary industrial embodiment of FIG. 3, dynamic designation may occur in response to a manufacturing controller Unit 1, i.e., device 15-5 (device type D1), seeking assistance from an automation robot 38. The robot 38, itself possibly a hybrid device-type as described above, may be multi-tasked at the plant with asset management functions, for instance, or quality control, defect analysis, repair, maintenance, etc. In the initial time window T1 of FIG. 3, the automation robot 38 may assign device 15-5 as the trusted designated node 15D. The robot 38 may thereafter dynamically update the IoT hub 11 once the second time window T2 commences.

In model 50 of FIG. 5, for example, the service-requesting initiator node (15I) such as the EV 16 of FIG. 1 may communicate with a designated node 15D, e.g., the EV charger 17 in this representative embodiment. Model 50 describes a “device-acquired” approach, in the sense that the initiator node 15I acting as a hybrid device-type determines/selects the designated node 15D from among neighboring/in-range nodes 15. Various communications are shown between the initiator node 15I, the trusted designated node 15D, and the IoT hubs 11A and 11B in FIG. 5. These include, from top to bottom in FIG. 5, node discovery 51 followed by request for designated node information 52. The initiator node 15I also initiates service authorization 53 with the IoT hub 11A. The trusted designated node 15D may provide its device type to the IoT hub 11B, i.e., as a message 54. The IoT hub 11A may send a message 55 to the initiator node 15I similar device type information as message 54.

Model 50 of FIG. 5 also illustrates admission control logic 57 for administration control, i.e., enabling the trusted designated node 15D to function as the proxy as it has been requested to do. The connected and provisioned status 58 may be communicated to the IoT hub 11A. Additional messages may include, when appropriate, a message 59 pertaining to rejection of the trusted designated node 15D for its designated proxy function and de-authorization. Decision feedback 60 is then communicated by the trusted designated node 15D to the initiator node 15I. A service activation message 61 may be communicated from the trusted designated node 15D to the IoT hub 11A, i.e., upon activation of the trusted designated node 15D.

The alternative hub-assisted model 50A of FIG. 6 may be used in instances in which a requesting device or initiator node 15I is unable to designate the trusted designated node 15D.

For example, the exemplary EV 16 of FIG. 1 may act as a recipient of a service and is in communication with the IoT hub 11. The EV 16 may transmit a request for service 63 to the IoT hub 11. The IoT hub 11 may thereafter send a resource availability request 64A to two possible candidate nodes, i.e., designated node 15D-1 and 15D-2. The candidates then reply with a message 67Y (yes) or 67N (no) indicating whether they can provide the requested service. The IoT hub 11 then processes these responses using its admission control logic 69 (analogous to logic 57 of FIG. 5).

Once the IoT hub 11 decides which candidate node to accept, in this case trusted designated node 15D-1 after it provides the message 67Y, the IoT hub 11 transmits a message 70 to the EV 16 to initiate acceptance of the service from the trusted designated node 15D-1. The EV 16, i.e., an onboard controller thereof, replies with an acceptance message 71 back to the capable trusted designated node 15D-1. The trusted designated node 15D-1 then sends a message 72 to the EV 16 that the trusted designated node 15D-1 is provisioned and connected. The EV 16 and trusted designated node 15D-1 thereafter exchange a message 73 indicating that the service is active and ongoing.

Referring now to FIG. 7, in some cases a device in the networked IoT ecosystem 10 or 10A may include multiple IoT hubs 11, e.g., hubs H1, H2, and H3. In the representative embodiment of FIG. 1, hubs H1, H2, and H3 may be embodied as multiple different control modules of the EV 16. A device with such connectivity options may require smart and consolidated optimization capabilities for assigning a trusted designated node 15D and for determining an energy-appropriate reporting cadence or periodicity. Various nodes 15 may serve as the initiator node 15I. A device acting as node N1 may communicate with hubs H1 and H3, while a device acting as node N2 may communicate with hub H2. Similarly, a device acting as node N3 may communicate with hub H3. In this example, therefore, node N1 has two possible communication options, i.e., hub H1 or hub H3.

In a situation in which one device uses multiple hubs, the act of sending periodic reports consumes significant processing power, requires coordination of sleep/wake cycles, and the like. To reduce power consumption, an aspect of the present strategy consolidates reports and determines an optimum time to send the reports/messages to one of the IoT hubs 11. Representative conditions are illustrated in condition table 75 as, e.g., energy budget, (energy) cost, communication coverage, latency, node proximity, and node priority, e.g., transit, designated, critical, etc. Based on these conditions, a population of candidate nodes 15 is recognized, from which a superior node is selected. In some embodiments, the various conditions may be normalized and weighted, such that collectively the condition table 75 outputs a binary decision (0 or 1) as to whether to assign the trusted designated node 15D or continue to use the initiator node 15I to communicate its status messages to the IoT hub 11.

In block 76, for instance, the nodes 15 are evaluated against the conditions of table 75 to determine trusted designated nodes 15D, shown as 15D-1 and 15D-2 for simplicity. Nodes 15N are disregarded as lacking the required capabilities in view of the conditions. Node 15* may be a possible designated node, but based on conditions and relative capabilities, the designated nodes 15D-1 and 15D-2 are deemed to be superior choices. Of the two remaining designated nodes 15D-1 and 15D-2, node 15D-2 may be presently occupied, i.e., engaged in performing functions that preclude its use as a trusted designated node 15D. This would leave node 15D-1 as available to serve and capable of serving as the trusted designated node 15D. Node 15D-1 in this example is then assigned as the trusted designated node 15D, followed by reporting (block 78). This occurs at the predetermined energy budget-based cadence discussed above with reference to FIG. 2.

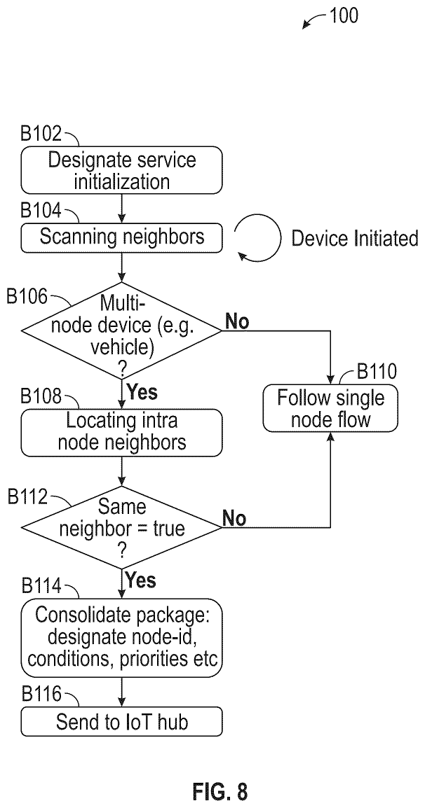

Referring to FIG. 8, an embodiment of a method 100 is described to illustrate an aspect of the present teachings. In general, the method 100 is directed to managing intranodal interactions in a networked IoT environment, with such a networked environment embodied herein as the IoT environment 10 and 10A of respective FIGS. 1 and 1A. The method 100 may include using a service-requesting, possibly high power initiator node 15I of the IoT environment 10, 10A, or the IoT hub 11, to identify a candidate smart device among a plurality of neighboring nodes 15. The candidate smart device may be high power, low power, or hybrid (flexibly operable as a low power device type or a high power device type) based on requirements of the initiator node 15I. The method 100 includes selectively assigning the candidate device as a trusted designated node 15D within the IoT environment 10, 10A based on a battery level or other parameter of the initiator node 15I. The method 100 also includes determining, based on a parameter of the initiator node 15I, an optimal periodicity of communication of status messages from the initiator node 15I to an IoT hub 11 of the IoT environment 10, 10A. The method 100 includes using the trusted designated node 15D for transmitting the status messages to the IoT hub 11 with the optimal periodicity. This action occurs via the designated node 15D such that the trusted designated node 15D negotiates periodicity and acts as a proxy for the initiator node 15I when reporting the status messages to the IoT hub 11.

A representative embodiment of the method 100 as shown in FIG. 8 begins at logic block B102. Here, the method 100 includes initializing or requesting a service via an initiator node 15I, for instance the EV 16 of FIG. 1. For example, the EV 16 may park in the smart garage 14 and enter an ignition-off state in proximity to the EV charger 17. In the manufacturing example of FIG. 3, an automation robot 38 or another device may serve in the role of the initiator node 15I. The method 100 then proceeds to block B104.

Block B104 entails scanning neighboring nodes 15 for candidate nodes, i.e., one or more nodes 15 that could possibly serve as the above-described trusted designated node 15D. Using the example of the EV 16, for instance, the EV 16 may scan for neighboring devices/nodes within its proximity range that could possibly serve as the trusted designated node 15D. The method 100 then proceeds to block B106.

At block B106, the method 100 includes determining if the initiator node 15I is a multi-node device. In keeping with the present vehicular example, the EV 16 would be such a device as the EV 16 would typically include multiple different control modules as noted above. Such characteristics are typical of a hybrid device-type. The method 100 proceeds to block B108 when the initiator node 15I is a multi-node device, and to block B110 in the alternative when the initiator node 15I is a single-node device.

Block B108 is arrived at from block B106 after a determination that the initiator node 15I is a multi-node device such as the EV 16. Block B108 includes locating intranode neighbors. As appreciated in the art, an intranode neighbor in the networked IoT infrastructure 10 is a neighboring device/node connected or belonging to the same local network segment as the scanning device. For instance, intranode neighbors may share a router or network connector in common. The method 100 proceeds to block B112 after locating intranode neighbors.

At block B110, the method 100 of FIG. 8 proceeds to follow a single-node flow, for instance as described above with reference to FIG. 1. The method 100 is then complete, with the single trusted designated node 15D thereafter functioning as a proxy for messaging by the initiator node 15D.

Block B112 includes determining if intranode neighbors are located at block B108. The method 100 proceeds to block B114 when an intranode neighbor is located. The method 100 proceeds in the alternative to block B110 when an intranode neighbor is not located.

Block B114 includes consolidating a message package as described above with reference to FIG. 7. The method 100 thereafter proceeds to block B116.

At block B116, the consolidated message is sent to the IoT hub 11, e.g., the IoT hub H1 or H3 of FIG. 7. The method 100 is then complete.

As set forth above, the present solutions are directed to methods and nodal systems for introducing a smart device as a designated node 15D into a networked IoT ecosystem such as the IoT ecosystem 10 and 10A of FIGS. 1 and 3, respectively. The designated node 15D, based on a parameter such as an energy budget of an initiator device (such as the EV 16 of FIG. 1), would then selectively negotiate an optimal engagement periodicity for message exchange with an IoT hub 11. Reporting by the trusted designated node 15D may be based on the parameter or current situation of the requesting device, for instance a battery level of the propulsion battery 22 or other battery of the EV 16.

The trusted designated node 15D may be classified as such and selected in some instances by the EV 16 or other initiator node/device. In other approaches, the IoT hub 11 may assist in the selection of the trusted designated node 15D. Reporting is then performed at an energy budget-appropriate cadence or periodicity. This action ensures that a high power device types like the EV 16 of FIG. 1 is usable as part of the IoT ecosystem 10, e.g., a Matter ecosystem, even when in a power-depleted state. This is ensured by using the trusted designated node 15D (e.g., the EV charger 17) as a proxy for device status reporting to the IoT hub 11. This in turn would help minimize power drain of the battery 22 of FIG. 1 in such an embodiment.

These and other attendant benefits will be readily appreciated by those possessing ordinary skill in the art in view of the foregoing disclosure.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method for managing communication between Internet-of-Things (IoT) nodes in a networked IoT environment having the IoT nodes and an IoT hub, the method comprising:
identifying, in response to a parameter of a service-requesting initiator node, a candidate smart device from among the IoT nodes;
selectively introducing the candidate smart device into the IoT environment, including assigning the candidate smart device as a trusted designated node within the IoT environment using the initiator node or the IoT hub;
determining, based on the parameter of the initiator node, an optimal periodicity of communication of status messages from the trusted designated node to the IoT hub; and
transmitting the status messages to the IoT hub with the optimal periodicity, via the trusted designated node, such that the trusted designated node acts as a proxy for the initiator node when reporting the status messages to the IoT hub.

2. The method of claim 1, wherein the initiator node includes a battery, and wherein the parameter includes a capacity level or state of charge of the battery.

3. The method of claim 2, wherein the initiator node is part of a vehicle having the battery, and wherein determining the optimal periodicity of communication of the status messages is based on the capacity level or state of charge of the battery.

4. The method of claim 3, wherein selectively introducing the candidate smart device into the IoT environment includes selectively introducing an electric vehicle charger into the IoT environment as the trusted designated node, and wherein the electric vehicle charger includes the candidate smart device.

5. The method of claim 1, wherein selectively introducing the candidate smart device into the IoT environment occurs during commissioning of the candidate smart device.

6. The method of claim 1, wherein determining the optimal periodicity of communication of status messages from the trusted designated node to the IoT hub includes accessing a lookup table that is indexed or referenced by the optimal periodicity and the parameter.

7. The method of claim 1, wherein selectively introducing the candidate smart device into the IoT environment includes dynamically assigning the candidate smart device type as the trusted designated node during operation of the IoT environment.

8. The method of claim 7, wherein the IoT environment is part of a manufacturing plant, and wherein dynamically assigning the candidate smart device as the trusted designated node includes dynamically assigning an automation robot or a controller of the manufacturing plant as the trusted designated node during operation of the manufacturing plant.

9. The method of claim 7, wherein dynamically assigning the candidate smart device as the trusted designated node is performed by the initiator node in accordance with a device-acquired model, further comprising:
selecting the trusted designated node via the initiator node from among neighboring/in-range nodes of the IoT nodes using the device-acquired model.

10. The method of claim 7, wherein dynamically assigning the candidate smart device as the trusted designated node is performed by the IoT hub in accordance with a hub-assisted model.

11. The method of claim 1, further comprising:
consolidating a status message of the initiator node with a status message of the trusted designated node to form a consolidated report; and
periodically sending the consolidated report to the IoT hub via the trusted designated node to thereby reduce power consumption of the IoT environment.

12. A networked Internet-of-Things (IoT) environment, comprising:
an IoT hub; and
a plurality of IoT devices including a service-requesting device (“initiator node”), wherein the IoT hub and/or the initiator node is operable for:
identifying, in response to a parameter of the initiator node, a candidate smart device from among the plurality of IoT devices; and
selectively introducing the candidate smart device into the IoT environment, including assigning the candidate smart device as a trusted designated node within the IoT environment, via the initiator node and/or the IoT hub, and wherein the trusted designated node is operable for:
determining, based on the parameter of the initiator node, an optimal periodicity of communication of status messages from the trusted designated node to the IoT hub; and
transmitting the status messages to the IoT hub with the optimal periodicity such that the trusted designated node acts as a proxy for the initiator node when reporting the status messages to the IoT hub.

13. The IoT environment of claim 12, wherein the initiator node includes a battery, and wherein the parameter includes a capacity level or state of charge of the battery.

14. The IoT environment of claim 13, wherein the initiator node is part of a high power device having the battery, and wherein the designated node is operable for determining the optimal periodicity of communication of the status messages based on the capacity level or the state of charge of the battery.

15. The IoT environment of claim 14, wherein the high power device is a battery charger for the battery, and wherein the IoT hub and/or the initiator node is operable for selectively introducing the candidate smart device into the IoT environment by selectively introducing the battery charger into the IoT environment as the trusted designated node.

16. The IoT environment of claim 12, wherein the trusted designated node is operable for determining the optimal periodicity of communication of status messages from the trusted designated node to the IoT hub by accessing a lookup table that is indexed or referenced by the optimal periodicity and the parameter.

17. The IoT environment of claim 12, wherein the IoT hub and/or the initiator node is operable for selectively introducing the candidate smart device into the IoT environment by dynamically assigning the candidate smart device as the trusted designated node during operation of the IoT environment.

18. The IoT environment of claim 17, wherein the initiator node is operable for dynamically assigning the candidate smart device as the trusted designated node within the IoT environment in accordance with a device-acquired model.

19. The IoT environment of claim 17, wherein the IoT hub is operable for dynamically assigning the candidate smart device as the trusted designated node within the IoT environment in accordance with a hub-assisted model.

20. An Internet-of-Things (IoT) environment, comprising:
an IoT hub;
a vehicle having a vehicle body, one or more road wheels connected to the vehicle body;
and a battery connected to the vehicle body, the battery having a capacity level or state of charge, wherein when the vehicle acts as a service-requesting device (“initiator node”) within the IoT environment; and
a vehicular infrastructure device, wherein the vehicle is operable for:
identifying, in response to the capacity level or state of charge, a candidate smart device from among a plurality of IoT devices of the IoT environment;
selectively introducing the candidate smart device into the IoT environment by assigning the candidate smart device as a trusted designated node within the IoT environment, wherein the vehicular infrastructure device is operable for:
determining, based on the capacity level or state of charge, an optimal periodicity of communication of status messages from the vehicular infrastructure device to the IoT hub; and
transmitting the status messages to the IoT hub with the optimal periodicity such that the vehicular infrastructure device acts as a proxy for the vehicle when reporting the status messages to the IoT hub.
